(19) United States
(12) Patent Application Publication
(10) Pub. No.: US 2026/0295723 A1
(43) Pub. Date: Oct. 1, 2026

(54) TWO-DIMENSIONAL MONITORING SYSTEM AND METHOD FOR LASER PROCESSING PROCESS BASED ON TRAJECTORY COMPENSATION MECHANISM

(71) Applicant: XI'AN JIAOTONG UNIVERSITY, Xi'an (CN)

(72) Inventors: Xuesong MEI, Xi'an (CN); Jinge HE, Xi'an (CN); Wanqin ZHAO, Xi'an (CN); Tao SUN, Xi'an (CN); Zhengjie FAN, Xi'an (CN); Jianlei CUI, Xi'an (CN); Wenjun WANG, Xi'an (CN); Bin LIU, Xi'an (CN); Wenqiang DUAN, Xi'an (CN); Aifei PAN, Xi'an (CN)

(73) Assignee: XI'AN JIAOTONG UNIVERSITY, Xi'an (CN)

(21) Appl. No.: 19/366,580

(22) Filed: Oct. 23, 2025

(30) Foreign Application Priority Data
Mar. 31, 2025 (CN) 2025103961051

(51) Int. Cl. B23K 26/082; B23K 26/03; B23K 26/70

(52) U.S. Cl. CPC B23K 26/082; B23K 26/032; B23K 26/702

(57) ABSTRACT

A two-dimensional monitoring system and method for a laser processing process based on a trajectory compensation mechanism are provided, including a laser light source, a probing module, a galvanometer scanner, a processing assembly, and a control module. The probing light beam from the probing module passes through the galvanometer scanner and is incident on the processing assembly, and the probing module collects returned light signals along the probing light scanning path; the processing light beam from the laser light source is incident on the processing module; the processing assembly processes the workpiece to be processed after coaxially coupling two beams of light; and the control module generates two-dimensional cross-sectional images based on light signals collected by the probing module. The present disclosure improves the controllability and stability of the processing process, and provides an intuitive and efficient online feedback means for laser processing quality control.

### CROSS-REFERENCE TO RELATED APPLICATIONS

The application claims priority to Chinese patent application No. 2025103961051, filed on Mar. 31, 2025, the entire contents of which are incorporated herein by reference.

### TECHNICAL FIELD

The present disclosure relates to the field of laser processing technology, and specifically to a two-dimensional monitoring system and method for a laser processing process based on a trajectory compensation mechanism.

### BACKGROUND

Laser processing has the advantages of high processing accuracy, efficiency, wide material processing range, non-contact processing, and no tool loss. In the actual operation of laser processing, due to the dual influence of its non-contact processing characteristics and Gaussian light transmission characteristics, it is difficult to effectively control the processing depth by means of axis feeding, and even within a certain range near the focus, the laser beam may damage the processed material. Moreover, the laser transmission process is extremely susceptible to interference from complex phenomena such as structural evolution and plasma eruption during processing, which makes the processing process fluctuate, making it difficult to ensure processing repeatability and stability, becoming a key factor restricting the improvement of its processing quality.

At present, the method to solve the instability of laser processing process is mainly to monitor the laser processing process, that is, by capturing the signals generated when the laser interacts with the processed material, analyzing the signal characteristics to acquire processing status information, so as to regulate the processing process. However, the connection between the signals and the processing process in the existing monitoring methods is mostly indirect, which cannot intuitively represent the real-time changes in the surface morphology of the material during the laser processing. In addition, a large number of preliminary experiments are required in the early stage to obtain monitoring parameters. It is difficult to achieve efficient and intuitive laser processing process monitoring, which limits the development of laser processing technology.

### SUMMARY

The purpose of the present disclosure is to provide a two-dimensional monitoring system and method for a laser processing process based on a trajectory compensation mechanism, which solves the problem that the connection between signals and processing processes in existing laser processing process monitoring methods is mostly indirect, and cannot intuitively represent the real-time changes in material morphology during laser processing, resulting in inaccurate monitoring results.

To achieve the preceding purpose, the present disclosure provides the following technical solutions:

On the one hand, a two-dimensional monitoring system for a laser processing process based on a trajectory compensation mechanism is provided, including a laser light source, a probing module, a galvanometer scanner, a processing assembly, and a control module, among them:
the probing light beam from the probing module passes through the galvanometer scanner and is incident on the processing assembly, and the probing module collects returned light signals along the probing light scanning path;
the processing light beam from the laser light source is incident on the processing module;
the processing assembly processes the workpiece to be processed after coaxially coupling two beams of light; and
the control module generates two-dimensional cross-sectional images for two-dimensional monitoring of the laser processing process based on light signals collected by the probing module.

Further, the processing assembly includes a processing module, a first dichroscope, a first focusing lens, and a processing platform, among them:
the processing light beam from the laser light source and the probing light beam from the probing module are both incident on the first dichroscope, the light beam from the first dichroscope is incident on the processing module, and the light beam from the processing module passes through the first focusing lens and is incident on the processing platform.

Further, the probing module includes a superluminescent diode (SLD) light source, a beam coupler, a first beam collimator, a second dichroscope, a second beam collimator, a third beam collimator, a second focusing lens, a third focusing lens, a reflector, a transmission grating, and a linear array camera, among them:
the probing light beam from the SLD light source is incident on the beam coupler, and one of the two probing light beams from the beam coupler passes through the first beam collimator and is incident on the second dichroscope;
the probing light beam from the second dichroscope is incident on the galvanometer scanner;
the other of the two probing light beams from the beam coupler passes through the second beam collimator and the second focusing lens in sequence and is incident on the reflector, and the probing light signal from the reflector passes through the second focusing lens and the second beam collimator in sequence and is incident on the beam coupler;
the two probing light signals received by the beam coupler pass through the third beam collimator, the transmission grating, and the third focusing lens in sequence and are incident on the linear array camera;
the linear array camera collects the returned light signals along the probing light scanning path; and
the industrial camera collects image information of the surface of the workpiece to be processed on the processing platform.

A two-dimensional monitoring method for a laser processing process based on a trajectory compensation mechanism includes the following steps:
Step 1, acquiring a probing light scanning path according to a preset laser processing trajectory, and setting the probing light scanning speed and the number of probing scans;
Step 2, generating a compensation motion trajectory of the galvanometer scanner according to the preset laser processing trajectory and laser processing speed, as well as the probing light scanning path, the probing light scanning speed, and the number of probing scans;
Step 3, using a pre-constructed motion trajectory-deflection model of the galvanometer scanner to convert the compensation motion trajectory of the galvanometer scanner into a motion parameter of the galvanometer scanner deflection angle;
Step 4, initializing the laser processing parameters, probing module parameters, and motion parameters of the galvanometer scanner deflection angle, synchronizing the laser light source, the processing assembly, the galvanometer scanner, and the probing module, laser processing the workpiece to be processed, and collecting returned light signals along the probing light scanning path; and
Step 5, acquiring two-dimensional cross-sectional images based on the obtained light signals, and using the two-dimensional cross-sectional images to perform two-dimensional monitoring of the laser processing process.

Further, the probing light scanning path is a straight line running through the laser processing trajectory.

Further, the compensation motion trajectory of the galvanometer scanner is generated by the following method:
calculating an offset between the processing light focus coordinates and the probing light focus coordinates corresponding to different times according to the preset laser processing trajectory and the laser processing speed, as well as the probing light scanning path, the probing light scanning speed, and the number of probing scans;
taking the obtained offset between the processing light focus coordinates and the probing light focus coordinates as the coordinate values of the compensation motion trajectory of the galvanometer scanner; and
splicing the obtained coordinate values of multiple compensation motion trajectories to generate the compensation motion trajectory of the galvanometer scanner.

Further, the specific method for constructing a motion trajectory-deflection model of the galvanometer scanner is as follows:
the galvanometer scanner, including an X-axis galvanometer lens and a Y-axis galvanometer lens, measures the distance between the X-axis galvanometer lens and the Y-axis galvanometer lens in the light path, the optical distance between the Y-axis galvanometer lens and the first dichroscope, and the distance between the first dichroscope and the processing platform to derive the relationship between any coordinates on the galvanometer scanner motion trajectory and the motion parameters of the galvanometer scanner deflection angle; and
reversely solving the relationship between any coordinates on the galvanometer scanner motion trajectory and the motion parameters of the galvanometer scanner deflection angle to obtain the motion trajectory-deflection model of the galvanometer scanner.

Further, the expression of the motion trajectory-deflection model of the galvanometer scanner is as follows:

$$θ x = arc tan \frac{x}{\sqrt{{( d + L )}^{2}} + e}$$

$$θ y = arc tan \frac{y}{d + L}$$

specifically, θx and θy are the deflection angles of the X-axis galvanometer lens and the Y-axis galvanometer lens, respectively; e is the distance between the X-axis galvanometer lens and the Y-axis galvanometer lens; d is the optical distance between the Y-axis galvanometer lens and the first dichroscope; L is the distance between the first dichroscope and the processing platform; and (x, y) are any coordinates on the galvanometer scanner motion trajectory.

Further, the specific method of acquiring two-dimensional cross-sectional images based on the obtained light signals is as follows:
interfering the obtained light signals in the probing module to obtain interference signals;
performing DC removal and wave number linearization preprocessing in terms of the obtained interference signals sequentially to obtain the preprocessed interference signals;
Fourier-transforming the obtained preprocessed interference signals to obtain point depth information at different times;
generating a three-dimensional point cloud data set from the point depth information at different times; and
using the obtained three-dimensional point cloud data set to generate two-dimensional cross-sectional images.

Further, between Step 3 and Step 4, the center position between the light spots of the probing light from the probing module and the processing light from the laser light source is adjusted so that the center position deviation of the light spots of the probing light and the processing light is less than a preset value.

Compared with the existing art, the present disclosure has the following beneficial effects:

The present disclosure provides a two-dimensional monitoring system for a laser processing process based on a trajectory compensation mechanism, which realizes coaxial coupling of interferometry and processing light paths by means of dichroscopes. Through the compensation of the motion trajectory of the processing assembly by the galvanometer scanner, the two-dimensional cross-sectional interferometry of the workpiece to be processed is realized, and the evolution process of the target cross-sectional morphology during the processing is monitored in real time. The present disclosure realizes real-time dynamic monitoring of the cross-sectional morphology of the workpiece to be processed during laser processing, improves the controllability and stability of the processing process, and provides an intuitive and efficient online feedback means for laser processing quality control.

The present disclosure provides a two-dimensional monitoring method for a laser processing process based on a trajectory compensation mechanism. First, the probing light scanning path is planned according to the laser processing path, and then the galvanometer scanner deflection angle is calculated in combination with the pre-constructed motion trajectory-deflection model of the galvanometer scanner. The workpiece to be processed is processed by synchronizing the processing assembly, the galvanometer scanner, and the probing module, and the light signals along the scanning path are collected at the same time. Finally, the light signals generate a two-dimensional cross-sectional morphology images, realizing two-dimensional morphology monitoring of the laser processing process. The present disclosure realizes real-time dynamic monitoring of the cross-sectional morphology of the workpiece to be processed during laser processing, improves the controllability and stability of the processing process, and provides an intuitive and efficient online feedback means for laser processing quality control.

### BRIEF DESCRIPTION OF DRAWINGS

FIG. 1 is a general flow chart of the method according to an embodiment of the present disclosure.

FIG. 2 is a schematic diagram of the method of a galvanometer scanner trajectory compensation algorithm according to an embodiment of the present disclosure.

FIG. 3 is a schematic diagram of a motion trajectory-deflection model of the galvanometer scanner according to an embodiment of the present disclosure.

FIG. 4 is a flow chart illustrating a method of the synchronous control system according to an embodiment of the present disclosure.

FIG. 5 is a flowchart illustrating a method for acquiring real-time two-dimensional cross-sectional morphology in laser processing according to an embodiment of the present disclosure.

FIG. 6 is a general schematic diagram of the system according to an embodiment of the present disclosure.

FIG. 7 is a schematic diagram of a probing module of the present disclosure.

### REFERENCE NUMERALS

1. laser; 2. first dichroscope; 3. processing assembly; 4. probing module; 5. galvanometer scanner; 6. first focusing lens; 7. processing platform; 8. control module; 9. computer; 10. industrial camera; 11. SLD light source; 12. fiber coupler; 13. first beam collimator; 14. transmission grating; 15. linear array camera; 16. reflector; 17. second beam collimator; 18. third beam collimator; 19. second focusing lens; 20. third focusing lens; and 21. second dichroscope.

### DETAILED DESCRIPTION OF THE EMBODIMENTS

In the following description, specific details such as specific system structures and technologies are proposed for illustration rather than limitation in order to thoroughly understand the embodiments of the present application. However, it should be clear to those skilled in the art that the present application can also be implemented in other embodiments without these specific details. In other cases, detailed descriptions of well-known systems, devices, circuits, and methods are omitted so that unnecessary details do not hinder the description of the present application.

It should be understood that when used in the present application's specification and the claims, the term “include/comprise” indicates the presence of the described features, wholes, steps, operations, elements and/or components, but does not exclude the presence or addition of one or more other features, wholes, steps, operations, elements, components and/or sets thereof.

It should also be understood that the term “and/or” used in the present application's specification and the appended claims refers to any combination of one or more of the associated listed items and all possible combinations, and includes these combinations.

As used in the specification and appended claims of the present application, the term “if” can be interpreted as “when . . . ” or “once” or “in response to determination” or “in response to detection” depending on the context. Similarly, the phrases “if determined” or “if [described condition or event] is detected” can be interpreted as meaning “once determined” or “in response to determination” or “once [described condition or event] is detected” or “in response to detection of [described condition or event]”, depending on the context.

In addition, in the description of the present application's specification and the appended claims, the terms, such as “first”, “second”, or “third”, are only used to distinguish the description and cannot be understood as indicating or implying relative importance.

References to “an embodiment” or “some embodiments” described in the specification of the present application mean that one or more embodiments of the present application include specific features, structures, or characteristics described in conjunction with the embodiment. Thus, the phrases “in an embodiment”, “in some embodiments”, “in some other embodiments”, “in some further embodiments” and the like appearing at different points in this specification do not necessarily refer to the same embodiment, but mean “one or more but not all embodiments”, unless otherwise specifically emphasized. The terms “include”, “comprise”, “have” and their variations mean “including but not limited to”, unless otherwise specifically emphasized.

### Embodiment 1

The purpose of this embodiment is to collect point depth information in the laser processing process in real time and construct dynamic two-dimensional cross-sectional morphology images through galvanometer scanner compensation scanning technology and synchronous control algorithm, combined with an optical coherent interferometry system, and solve the defects of traditional monitoring methods that rely on indirect signals, require pre-experimental parameters and cannot intuitively reflect material morphology changes. In this way, the present disclosure realizes efficient online two-dimensional visualization monitoring of the processing process, improves the stability and controllability of laser processing, and provides intuitive and efficient online feedback means for laser processing quality control.

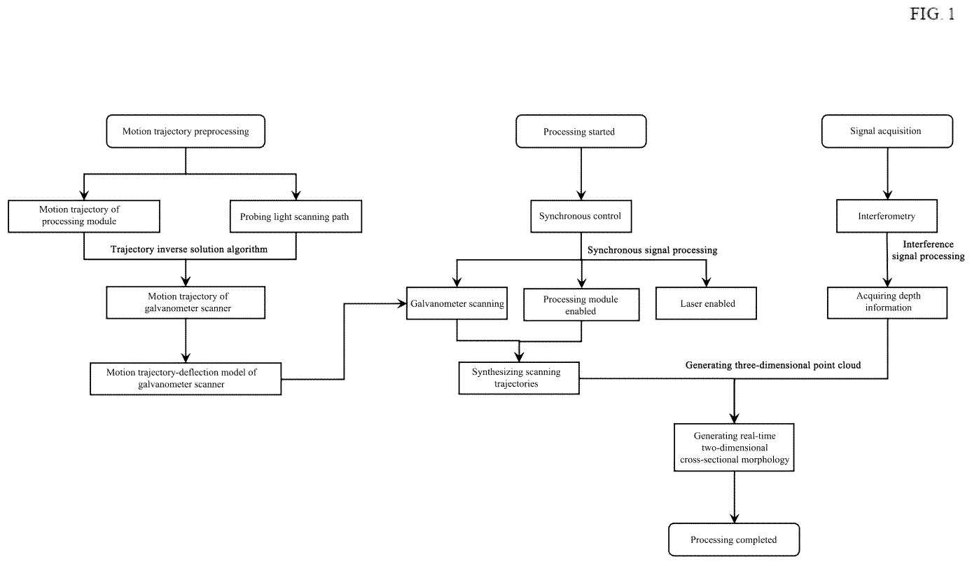

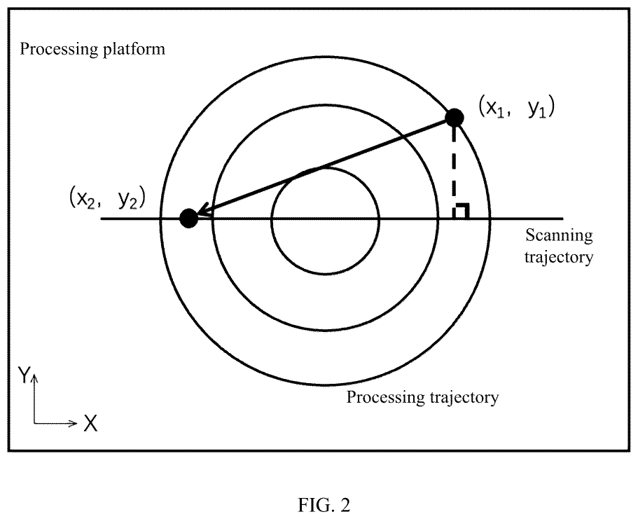

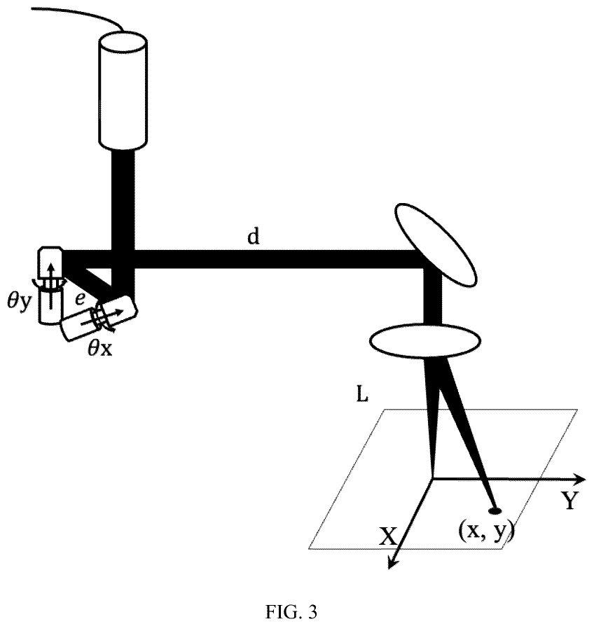

As shown in FIGS. 1 to 6, a two-dimensional monitoring method for a laser processing process based on a trajectory compensation mechanism provided by this embodiment includes the following steps:
Step 1, choosing a straight line running through the laser processing trajectory as the probing light scanning path according to a preset laser processing trajectory of a workpiece to be processed; calculating a probing light scanning speed V=L*f according to the hardware parameters of a probing module 4, and a preset probing light scanning distance L and scanning frequency f,
as shown in FIG. 2, calculating offsets Δx=x₁−x₂ and Δy=y₁−y₂ between the processing light focus coordinates (x₁, y₁) and the probing light focus coordinates (x₂, y₂) corresponding to different times according to the preset laser processing trajectory and the laser processing speed, as well as the probing light scanning path, the probing light scanning speed, and the number of probing scans;
taking the offsets of the X-axis and the Y-axis as the coordinate values of the compensation motion trajectory of the galvanometer scanner 5, based on which the compensation motion coordinates of the galvanometer scanner 5 corresponding to different times T can be obtained, and splicing the obtained coordinates to generate the compensation motion trajectory of the galvanometer scanner 5;
Step 2, constructing a mapping relationship between the galvanometer scanner deflection angle and motion trajectory coordinates of the galvanometer scanner based on the motion trajectory-deflection model of the galvanometer scanner; and
as shown in FIG. 3, measuring the distance e between the X-axis galvanometer lens and the Y-axis galvanometer lens, the optical distance d between the Y-axis galvanometer lens and the first dichroscope 2, and the distance L between the first dichroscope 2 and the processing platform 7 to derive the relationship between any coordinates (x, y) on the galvanometer scanner motion trajectory and the deflection angles θx and θy of the galvanometer scanner according to the geometric relationship, being expressed as follows:

$$x = ( \sqrt{{y}^{2} + {( d + L )}^{2}} + e ) tan θ x$$

$$y = ( d + L ) tan θy$$

The motion trajectory-deflection model of the galvanometer scanner can be obtained by reversely solving the angles θx and θy, as shown below:

$$θ x = arc tan \frac{x}{\sqrt{{( d + L )}^{2}} + e}$$

$$θ y = arc tan \frac{y}{d + L}$$

According to the motion trajectory-deflection model of the galvanometer scanner, the compensation motion trajectory of the galvanometer scanner obtained in Step 1 is converted into motion parameters of the galvanometer scanner deflection angle, in which the motion parameters of the galvanometer scanner deflection angle include the deflection angle and the angular velocity, which are saved in the control module 8 as motion parameters of the galvanometer scanner compensation motion.
Step 3, presetting marking points on the surface of the workpiece to be processed as positioning references, in which an industrial camera 10 collects images of the processing area corresponding to the workpiece to be processed through the coaxial light path formed by coaxially coupling the probing light with the industrial camera, and completes the visual positioning of the processing area and the overlap of the processing light spot and the probing light spot in combination with an image processing algorithm to ensure the accuracy of the calculation of the compensation trajectory.

With the image processing algorithm, the original image is subjected to Gaussian filtering and edge detection algorithm to extract the contour information of marks, calculate the center coordinates of the marking points (x₀, y₀), turn on the processing light and the probing light respectively, obtain the position deviation between the processing light spot and the probing light spot after collecting the two spot images, adjust the position and angle of the optical element in the light path, and realize the overlap of the double spots; and
Step 4, initializing the laser processing parameters, probing module 4 parameters, and motion parameters of the galvanometer scanner, and synchronizing the laser 1, the processing assembly, the galvanometer scanner 5, and the probing module 4 by means of the control module 8 to complete the processing of the workpiece to be processed and collect returned light signals along the probing light scanning path, processing the light signals to construct two-dimensional cross-sectional images, and using the two-dimensional cross-sectional images to perform two-dimensional monitoring of the laser processing process.

The laser processing parameters include laser power, laser frequency repetition, processing trajectory, and processing speed.

The probing module parameters include the trigger mode, line scanning speed, and exposure time of the linear array camera 15.

The motion parameters of the galvanometer scanner include the motion parameters of the galvanometer scanner deflection angle obtained in Step 2.

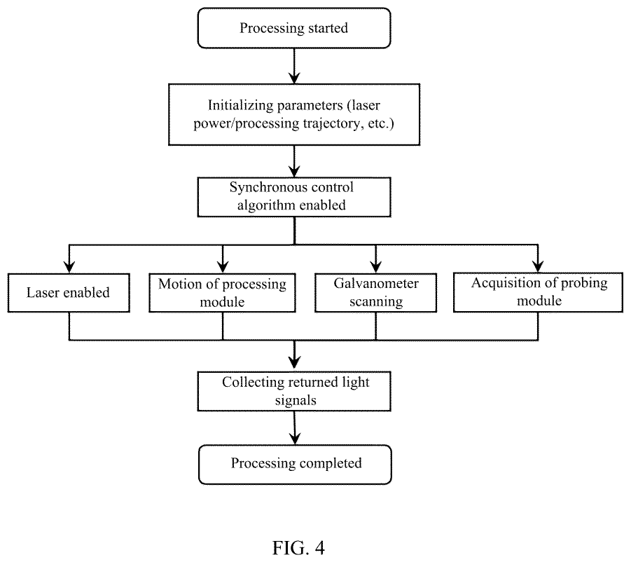

As shown in FIG. 4, after initializing the parameters, the synchronous control algorithm is started by the control module 8 to control the laser 1 to be turned on, the processing assembly to move, the galvanometer scanner 5 to scan, and the probing module 4 to collect data at the same time, ensuring that the probing light can move according to the preset scanning path along the preset processing trajectory, and the returned light signals are collected by the probing module 4; when the processing of the workpiece to be processed is completed this time, the processing process is stopped.

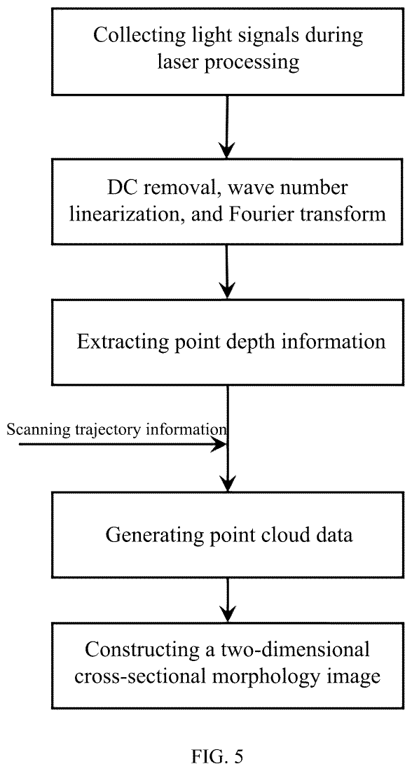

The light signals are processed to construct two-dimensional cross-sectional images, as shown in FIG. 5, and the specific method flow is as follows:

After entering the beam coupler 12 in the probing module 4, the returned light signals interfere with the probing light signals reflected back by the reflector 16 in the probing module 4 and are collected by the linear array camera 15;
the interference signals are pre-processed with DC removal and wave number linearization, and then demodulated by Fourier transform to acquire point depth information at different times T; and
combined with the probing light scanning path in Step 1, after each probing light completes scanning, the point depth information under the corresponding scanning trajectory is acquired and a three-dimensional point cloud data set is generated based on this. The point cloud is projected onto the X-Z plane (along the scanning path direction), and an interpolation algorithm is used to generate two-dimensional cross-sectional images.

In the present application, in laser processing, with the optical coherence imaging technology, the probing light is actively emitted to the processing area (such as a molten pool, keyhole or hole), and the reflected probing light signals are used to generate two-dimensional cross-sectional images, which can directly present the geometric structure changes of the processing area. For example, in a laser welding process, the two-dimensional cross-sectional images can display the depth and roughness of the keyhole and the fluctuation state of the molten pool in real time. These morphological parameters are directly related to the processing quality. For example: in laser drilling, the two-dimensional cross-sectional images can clearly show the depth of the hole, the uniformity of the aperture, and the penetration state of the bottom of the hole.

The current online monitoring method for laser processing is mainly based on passively capturing various signals generated when the laser interacts with matter, and using different signal processing methods to classify and analyze them. This type of monitoring method cannot intuitively represent the real-time changes in material morphology during laser processing, and it is difficult to directly acquire coordinate information such as depth and aperture. Moreover, in the actual application process of laser processing monitoring, different application scenarios, processing parameters, and experimental conditions will affect the actual effect of these monitoring methods. Therefore, a large number of preliminary tests are often required before starting real-time processing monitoring. Whenever it is necessary to change the use scenario or replace the processing materials, repeated preliminary experiments are required. The optical coherence imaging technology is different from traditional monitoring methods because it does not need to passively receive the signals generated by processing, but actively emits probing light to a sample. By means of galvanometer scanning, two-dimensional images of the processing process can be clearly and intuitively obtained to characterize the microstructural changes of the sample. Moreover, this method does not require a large number of preliminary experiments. Different experimental conditions and processing parameters will not affect the online monitoring images. The time for preliminary work is reduced. In addition, the method can also be coaxially coupled with a processing system and has strong adaptability to various laser processing scenarios.

### Embodiment 2

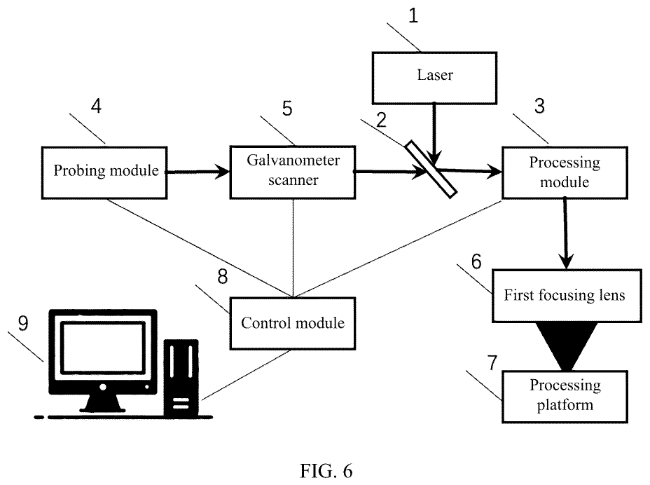

As shown in FIG. 6, a two-dimensional monitoring system for a laser processing process based on a trajectory compensation mechanism provided in this embodiment includes a laser light source (i.e., laser 1 in this embodiment), a first dichroscope 2, a processing module 3, a probing module 4, a galvanometer scanner 5, a first focusing lens 6, a processing platform 7, a control module 8, and a computer 9, among them:
the laser beam from the laser 1 enters the processing module 3 after being reflected by the first dichroscope 2, and is output from the processing module 3 to the first focusing lens 6 for focusing, and then acts on the workpiece to be processed on the processing platform 7.

The probing light emitted by the probing module 4 is deflected by the galvanometer scanner 5, transmitted through the first dichroscope 2, and coaxially coupled with the processing laser beam. After entering the processing module 3, it is output to the first focusing lens 6 and then focused on the workpiece to be processed.

The processing module 3 includes a laser processing device that can preset the processing trajectory, such as a rotary cutting head, a processing galvanometer scanner or a multi-axis motion table.

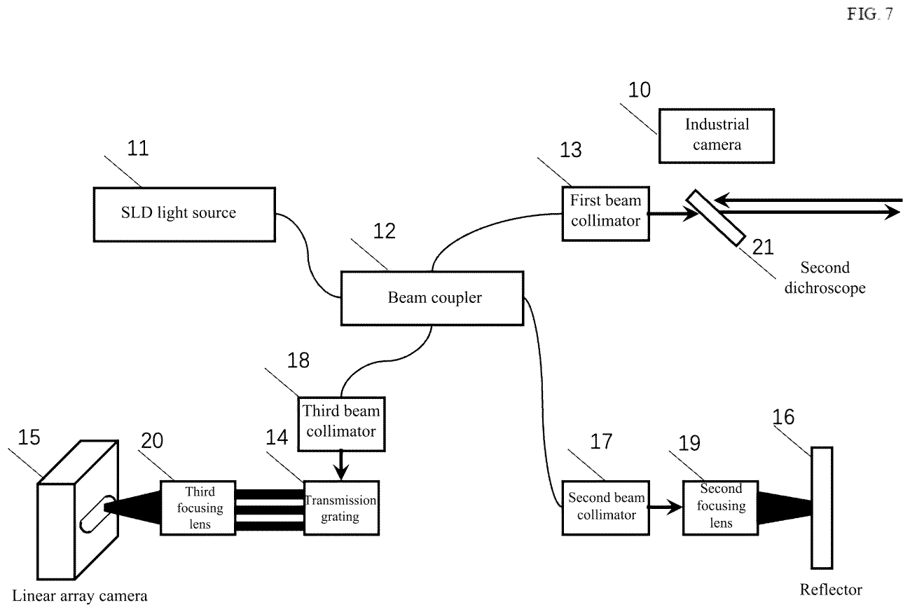

As shown in FIG. 7, the probing module 4 includes an industrial camera 10, an SLD light source 11, a fiber coupler 12, a first beam collimator 13, a transmission grating 14, a linear array camera 15, a reflector 16, a second beam collimator 17, a third beam collimator 18, a second focusing lens 19, a third focusing lens 20, and a second dichroscope 21, among them:
the laser beam emitted by the SLD light source 18 is transmitted to the beam coupler 12 by means of an optical fiber, and is divided into two beams by the beam coupler 12. One probing light beam passes through the first beam collimator 13 and the second dichroscope 21 and is transmitted out of the probing module 4, and then it is reflected on the workpiece to be processed. The other probing light beam is focused on the reflector 16 by means of the second focusing lens 19 after passing through the second beam collimator 17 and then reflected back to the beam coupler 12. It interferes with the returned light signals during processing (i.e., the light signal reflected back from the workpiece to be processed) in the beam coupler 12, passes through the third beam collimator 18 and then enters the transmission grating 14, and is focused by the third focusing lens 20 and then collected by the linear array camera 15.

The industrial camera 10 collects image information of the surface of the workpiece to be processed.

The control module 8 includes a system that can output synchronous control signals, such as a motion control card and a signal generator.

### Embodiment 3

Taking the processing of blade air film cooling holes as an example, nickel-based high-temperature alloy blades are used as workpieces to be processed, and the rotary cutting head is used as processing module 3. The processing mainly includes the following steps:
Step 1, determining the processing parameters of the rotary cutting head according to the diameter, depth, and inclination angle of the blade air film cooling hole to be processed, and choosing concentric circle rotary cutting for the processing trajectory;
Step 2, taking a straight line running through the center of the concentric circle in the processing area on the processing platform 7 as the probing light scanning path, calculating the offsets Δx=x₁−x₂ and Δy=y₁−y₂ between the processing light focus coordinates (x₁, y₁) and the probing light focus coordinates (x₂, y₂) at different times T according to the processing trajectory, the processing speed, the probing light scanning path, the probing light scanning speed, and the number of probing scans, using the offsets of the X-axis and the Y-axis as the coordinate values of the compensation motion trajectory of the galvanometer scanner 5, and calculating the change of the deflection angle during processing according to the motion trajectory-deflection model of the galvanometer scanner;
Step 3, turning on the probing module 4 and the laser demonstration light, using the industrial camera 10 to collect image information of the surface of the workpiece to be processed, extracting the center position of the processing light and the probing light spots with the edge detection algorithm, adjusting the positions of the first dichroscope 2 and the first focusing lens 6, so that the deviation between the processing light and the probing light centers is less than 1 μm;
Step 4, initializing the laser processing parameters including laser power, processing speed of the rotary cutting head, and galvanometer scanner compensation trajectory, and using the motion control card to generate synchronization signals, control the laser light output, rotation of the rotary cutting head, galvanometer scanner deflection and linear array camera exposure, where the linear array camera 15 collects the returned interference signals, and the industrial camera 10 monitors the orifice morphology in real time; and
Step 5, performing DC removal, wave number linearization, and Fourier transform on the interference signal to analyze the hole depth z, combining with the probing light scanning path information after each scan to generate multiple sets of three-dimensional point cloud data after mutual matching, and after projecting them onto the scanning section, obtaining real-time two-dimensional cross-sectional morphology images of the blade air film cooling holes.

### Embodiment 4

Taking laser melting processing of rotor parts as an example, a processing galvanometer scanner is used as the processing module 3, and the workpiece to be processed is made of 316L stainless steel. The processing mainly includes the following steps:
Step 1, planning a rotor profile on a stainless steel powder bed, and reciprocating filling the scanning path of the processing galvanometer scanner;
Step 2, taking a position offset by 0.1 mm along the scanning trajectory of the processing galvanometer scanner as the probing light scanning path, covering the edge of the molten pool, calculating the offsets Δx=x₁−x₂ and Δy=y₁−y₂ between the processing light focus coordinates (x₁, y₁) and the probing light focus coordinates (x₂, y₂) at different times T according to the processing trajectory, processing speed, probing light scanning path, probing light scanning speed, and the number of probing scans set according to the imaging speed of the probing module, using the offsets of the X-axis and the Y-axis as the coordinate values of the compensation motion trajectory of the galvanometer scanner 5, and calculating the change of the deflection angle during processing according to the motion trajectory-deflection model of the galvanometer scanner;
Step 3, turning on the probing module 4 and the laser demonstration light, using the industrial camera 10 to collect images, extracting the center position of the processing light and the probing light spots with the edge detection algorithm, adjusting the positions of the first dichroscope 2 and the first focusing lens 6, so that the deviation between the processing light and the probing light centers is less than 1 μm;
Step 4, initializing the laser processing parameters including laser power, processing speed of the processing galvanometer scanner, and galvanometer scanner compensation trajectory, and using the motion control card to generate synchronization signals, control the laser light output, rotation of the processing galvanometer scanner, galvanometer scanner deflection and linear array camera exposure, where the linear array camera 15 collects the returned interference signals, and the industrial camera 10 monitors the dynamics of the molten pool in real time; and
Step 5, performing DC removal, wave number linearization, and Fourier transform on the interference signal to analyze the molten pool depth z, combining with the probing light scanning path information after each scan to generate multiple sets of three-dimensional point cloud data after mutual matching, and after projecting them onto the scanning section, obtaining real-time two-dimensional cross-sectional morphology images of the molten pool.

It should be noted that the above embodiments are only used to illustrate the technical solutions of the present application, and are not intended to limit them. Although the present application has been described in detail with reference to the aforementioned embodiments, those of ordinary skill in the art will appreciate that modifications can still be made to the technical solutions described in the aforementioned embodiments, or equivalents may be substituted for certain technical features. Such modifications or substitutions do not make the essence of the corresponding technical solutions depart from the spirit and scope of the technical solutions of the embodiments of the present application and should fall within the protection scope of the present application.

What is claimed is:

1. A two-dimensional monitoring system for a laser processing process based on a trajectory compensation mechanism, comprising a laser light source, a probing module (4), a galvanometer scanner (5), a processing assembly, and a control module (8), wherein
the probing light beam from the probing module (4) passes through the galvanometer scanner (5) and is incident on the processing assembly, and the probing module (4) collects returned light signals along the probing light scanning path;
the processing light beam from the laser light source is incident on the processing module (3);
the processing assembly processes the workpiece to be processed after coaxially coupling two beams of light; and
the control module (8) generates two-dimensional cross-sectional images for two-dimensional monitoring of the laser processing process based on light signals collected by the probing module (4).

2. The two-dimensional monitoring system for a laser processing process based on a trajectory compensation mechanism according to claim 1, wherein the processing assembly comprises a processing module (3), a first dichroscope (2), a first focusing lens (6), and a processing platform (7), wherein
the processing light beam from the laser light source and the probing light beam from the probing module (4) are both incident on the first dichroscope (2), the light beam from the first dichroscope (2) is incident on the processing module (3), and the light beam from the processing module (3) passes through the first focusing lens (6) and is incident on the processing platform (7).

3. The two-dimensional monitoring system for a laser processing process based on a trajectory compensation mechanism according to claim 2, wherein the probing module (4) comprises an SLD light source (11), a beam coupler (12), a first beam collimator (13), a second dichroscope (21), a second beam collimator (17), a third beam collimator (18), a second focusing lens (19), a third focusing lens (20), a reflector (16), a transmission grating (14), and a linear array camera (15), wherein
the probing light beam from the SLD light source (11) is incident on the beam coupler (12), and one of the two probing light beams from the beam coupler (12) passes through the first beam collimator (13) and is incident on the second dichroscope (21);
the probing light beam from the second dichroscope (21) is incident on the galvanometer scanner (5);
the other of the two probing light beams from the beam coupler (12) passes through the second beam collimator (17) and the second focusing lens (19) in sequence and is incident on the reflector (16), and the probing light signal from the reflector (16) passes through the second focusing lens (19) and the second beam collimator (17) in sequence and is incident on the beam coupler (12);
the two probing light signals received by the beam coupler (12) pass through the third beam collimator (18), the transmission grating (14), and the third focusing lens (20) in sequence and are incident on the linear array camera (15);
the linear array camera (15) collects the returned light signals along the probing light scanning path; and
the industrial camera (10) collects image information of the surface of the workpiece to be processed on the processing platform (7).

4. A two-dimensional monitoring method for a laser processing process based on a trajectory compensation mechanism, based on a two-dimensional monitoring system for a laser processing process based on a trajectory compensation mechanism according to claim 1, comprising the following steps:
Step 1, acquiring a probing light scanning path according to a preset laser processing trajectory, and setting the probing light scanning speed and the number of probing scans;
Step 2, generating a compensation motion trajectory of the galvanometer scanner (5) according to the preset laser processing trajectory and laser processing speed, as well as the probing light scanning path, the probing light scanning speed, and the number of probing scans;
Step 3, using a pre-constructed motion trajectory-deflection model of the galvanometer scanner to convert the compensation motion trajectory of the galvanometer scanner (5) into a motion parameter of the galvanometer scanner deflection angle;
Step 4, initializing the laser processing parameters, probing module parameters, and motion parameters of the galvanometer scanner deflection angle, synchronizing the laser light source, the processing assembly, the galvanometer scanner (5), and the probing module (4), laser processing the workpiece to be processed, and collecting returned light signals along the probing light scanning path; and
Step 5, acquiring two-dimensional cross-sectional images based on the obtained light signals, and using the two-dimensional cross-sectional images to perform two-dimensional monitoring of the laser processing process.

5. The two-dimensional monitoring method for a laser processing process based on a trajectory compensation mechanism according to claim 4, wherein the probing light scanning path is a straight line running through the laser processing trajectory.

6. The two-dimensional monitoring method for a laser processing process based on a trajectory compensation mechanism according to claim 4, wherein the specific method for generating the compensation motion trajectory of the galvanometer scanner (5) is as follows:
calculating an offset between the processing light focus coordinates and the probing light focus coordinates corresponding to different times according to the preset laser processing trajectory and the laser processing speed, as well as the probing light scanning path, the probing light scanning speed, and the number of probing scans;
taking the obtained offset between the processing light focus coordinates and the probing light focus coordinates as the coordinate values of the compensation motion trajectory of the galvanometer scanner (5); and
splicing the obtained coordinate values of multiple compensation motion trajectories to generate the compensation motion trajectory of the galvanometer scanner (5).

7. The two-dimensional monitoring method for a laser processing process based on a trajectory compensation mechanism according to claim 4, wherein the specific method for constructing a motion trajectory-deflection model of the galvanometer scanner is as follows:
the galvanometer scanner (5), including an X-axis galvanometer lens and a Y-axis galvanometer lens, measures the distance between the X-axis galvanometer lens and the Y-axis galvanometer lens in the light path, the optical distance between the Y-axis galvanometer lens and the first dichroscope (2), and the distance between the first dichroscope (2) and the processing platform (7) to derive the relationship between any coordinates on the galvanometer scanner motion trajectory and the motion parameters of the galvanometer scanner deflection angle; and
reversely solving the relationship between any coordinates on the galvanometer scanner motion trajectory and the motion parameters of the galvanometer scanner deflection angle to obtain the motion trajectory-deflection model of the galvanometer scanner.

8. The two-dimensional monitoring method for a laser processing process based on a trajectory compensation mechanism according to claim 7, wherein the expression of the motion trajectory-deflection model of the galvanometer scanner is as follows:
$$θ x = arc tan \frac{x}{\sqrt{{( d + L )}^{2}} + e}$$
$$θ y = arc tan \frac{y}{d + L}$$
wherein, θx and θy are the deflection angles of the X-axis galvanometer lens and the Y-axis galvanometer lens, respectively; e is the distance between the X-axis galvanometer lens and the Y-axis galvanometer lens; d is the optical distance between the Y-axis galvanometer lens and the first dichroscope (2); L is the distance between the first dichroscope (2) and the processing platform (7); and (x, y) are any coordinates on the galvanometer scanner motion trajectory.

9. The two-dimensional monitoring method for a laser processing process based on a trajectory compensation mechanism according to claim 4, wherein the specific method of acquiring two-dimensional cross-sectional images based on the obtained light signals is as follows:
interfering the obtained light signals in the probing module (4) to obtain interference signals;
performing DC removal and wave number linearization preprocessing in terms of the obtained interference signals sequentially to obtain the preprocessed interference signals;
Fourier-transforming the obtained preprocessed interference signals to obtain point depth information at different times;
generating a three-dimensional point cloud data set from the point depth information at different times; and
using the obtained three-dimensional point cloud data set to generate two-dimensional cross-sectional images.

10. The two-dimensional monitoring method for a laser processing process based on a trajectory compensation mechanism according to claim 4, wherein between Step 3 and Step 4, the center position between the light spots of the probing light from the probing module (4) and the processing light from the laser light source is adjusted so that the center position deviation of the light spots of the probing light and the processing light is less than a preset value.
